(19) United States
(12) Patent Application Publication
(10) Pub. No.: US 2025/0357511 A1
(43) Pub. Date: Nov. 20, 2025

(54) APPARATUS AND METHOD FOR CONTROLLING AIR SUPPLY INTO FUEL CELL STACK

(71) Applicants: Hyundai Motor Company, Seoul (KR); Kia Corporation, Seoul (KR)

(72) Inventors: Sung Hun Kim, Hwaseong-si (KR); Ju Yong Lee, Hwaseong-si (KR)

(21) Appl. No.: 18/926,854

(22) Filed: Oct. 25, 2024

(30) Foreign Application Priority Data
May 20, 2024 (KR) 10-2024-0065367

(51) Int. Cl. H01M 8/04746; H01M 8/04082; H01M 8/04089; H01M 8/04111; H01M 8/04228; H01M 8/04303; H01M 8/04537; H01M 8/04858

(52) U.S. Cl. CPC H01M 8/04753; H01M 8/04104; H01M 8/04111; H01M 8/04201; H01M 8/04228; H01M 8/04303; H01M 8/04559; H01M 8/04776; H01M 8/0488

(57) ABSTRACT

An apparatus and a method for controlling air supply into a fuel cell stack are disclosed. The apparatus can include an air cut-off valve that adjusts the air supply into the fuel cell stack, an air pressure control valve that adjusts air pressure supplied to the fuel cell stack, and a control unit that cooperatively controls the air cut-off valve and the air pressure control valve, such that a voltage of the fuel cell stack is maintained as a lower limit voltage if entering a fuel cell stop mode.

### CROSS-REFERENCE TO RELATED APPLICATIONS

This application claims the benefit of Korean Patent Application No. 10-2024-0065367, filed on May 20, 2024, which application is hereby incorporated herein by reference.

### TECHNICAL FIELD

The present disclosure relates to an apparatus and a method for controlling air supply into a fuel cell stack to control an air processing system (APS) valve if a fuel cell is stopped.

### BACKGROUND

An air cut-off valve (ACV) located at a front stage of the stack is used to control a fuel cell stack voltage (hereinafter referred to as a “stack voltage”), if a fuel cell is stopped. The ACV is a part for blocking air introduced into the stack after a vehicle is stopped. The ACV has a driving scheme for turning on/off to complete opening and complete closing, if the vehicle is turned on and stopped. A rubber lip seal is used to increase the cut-off performance of the ACV. If the closing of the ACV is excessively repeated to stop a fuel cell, the rubber is worn out and an original function is lost. Furthermore, as the amount of operation of the ACV increases, a brush of a direct current (DC) motor is worn out.

If controlling to avoid an opening degree interval in which the rubber lip seal is worn out to improve this, it is impossible to follow a voltage. If a DC motor with a motor brush changes to a brushless direct current (BLDC) motor without the motor brush, it is required to develop a new control unit to cause excessive cost increases.

### SUMMARY

An embodiment of the present disclosure can solve the above-mentioned problems occurring in the prior art while advantages achieved by the prior art can be maintained intact.

An embodiment of the present disclosure can provide an apparatus and a method for controlling air supply into a fuel cell stack to control an air processing system (APS) to limit a voltage lower limit of a stack voltage, if stopping a fuel cell, with regard to a hardware characteristic and function of the APS.

An embodiment of the present disclosure can provide an apparatus and a method for controlling air supply into a fuel cell stack to cooperatively control an air cut-off valve (ACV) and an air pressure control valve (APC) to control a stack voltage in a certain range in an idle state of a fuel cell stack.

Technical problems to be solved by an embodiment of the present disclosure are not necessarily limited to the aforementioned problems, and other technical problems not mentioned herein can be solved by an embodiment of the present disclosure as will can be understood from the following description by those skilled in the art to which the present disclosure pertains.

According to an embodiment of the present disclosure, an apparatus for controlling air supply into a fuel cell stack may include an air cut-off valve that adjusts the air supply into the fuel cell stack, an air pressure control valve that adjusts air pressure supplied to the fuel cell stack, and a control unit that cooperatively controls the air cut-off valve and the air pressure control valve, such that a voltage of the fuel cell stack can be maintained as a predetermined lower limit voltage if entering a fuel cell stop mode.

The air cut-off valve may include a first valve disposed on an inlet of the fuel cell stack, a second valve disposed on an outlet of the fuel cell stack, and a bypass flow path formed between the first valve and the second valve to bypass air introduced into the fuel cell stack. An area of the bypass flow path may be formed by being expanded at a predetermined area expansion ratio.

The air pressure control valve may include a shaft and a disk fastened in a single offset structure on the basis of the shaft. The disk may be formed in an airtight structure with an exhaust pipe.

The control unit may open the air cut-off valve to a predetermined first opening degree and may completely close the air pressure control valve for voltage drop control of the fuel cell stack, after entering the fuel cell stop mode, and may completely open the air cut-off valve to maintain the voltage of the fuel cell stack within an allowable range with respect to the predetermined lower limit voltage, if the voltage of the fuel cell stack reaches the predetermined lower limit voltage, and may repeatedly control to open and close the air pressure control valve to a predetermined second opening degree based on the voltage of the fuel cell stack.

The control unit may initiate the voltage drop control of the fuel cell stack, if the voltage of the fuel cell stack reaches a predetermined upper limit voltage, after entering the fuel cell stop mode.

The control unit may completely close the air pressure control valve, before the voltage of the fuel cell stack reaches an upper limit of the allowable range with respect to the predetermined lower limit voltage, and may open the air pressure control valve to the second opening degree, before the voltage of the fuel cell stack reaches a lower limit of the allowable range with respect to the predetermined lower limit voltage.

The control unit may alternately control to change an opening degree of the air pressure control valve from the complete closing to the second opening degree or change the opening degree of the air pressure control valve from the second opening degree to the complete closing, based on predetermined opening degree change timing information.

The control unit may completely open the air cut-off valve and the air pressure control valve for voltage rise control of the fuel cell stack, if entering a refresh mode.

The control unit may open the air pressure control valve to a predetermined opening degree and may control revolutions per minute (RPM) of an air compressor upward, if entering a refresh mode.

The control unit may determine opening degrees of the air cut-off valve and the air pressure control valve, based on at least one of a target voltage, a voltage rise speed, a voltage drop speed, voltage responsiveness, or a cell voltage deviation, or any combination thereof.

According to an embodiment of the present disclosure, a method for controlling air supply into a fuel cell stack may include determining whether to enter a fuel cell stop mode and cooperatively controlling an air cut-off valve and an air pressure control valve, such that a voltage of a fuel cell stack is maintained as a predetermined lower limit voltage, if it is determined to enter the fuel cell stop mode.

The cooperatively controlling of the air cut-off valve and the air pressure control valve may include a voltage drop control step of opening the air cut-off valve to a predetermined first opening degree and completely closing the air pressure control valve for voltage drop control of the fuel cell stack, after entering the fuel cell stop mode, and a voltage maintenance control step of completely opening the air cut-off valve to maintain the voltage of the fuel cell stack within an allowable range with respect to the predetermined lower limit voltage, if the voltage of the fuel cell stack reaches the predetermined lower limit voltage, and repeatedly controlling to open and close the air pressure control valve to a predetermined second opening degree based on the voltage of the fuel cell stack.

The voltage drop control step may include initiating the voltage drop control of the fuel cell stack, if the voltage of the fuel cell stack reaches a predetermined upper limit voltage, after entering the fuel cell stop mode.

The voltage maintenance control step may include completely closing the air pressure control valve, before the voltage of the fuel cell stack reaches an upper limit of the allowable range with respect to the predetermined lower limit voltage and opening the air pressure control valve to the second opening degree, before the voltage of the fuel cell stack reaches a lower limit of the allowable range with respect to the predetermined lower limit voltage.

The voltage maintenance control step may include alternately controlling to change an opening degree of the air pressure control valve from the complete closing to the second opening degree or change the opening degree of the air pressure control valve from the second opening degree to the complete closing, based on predetermined opening degree change timing information.

The cooperatively controlling of the air cut-off valve and the air pressure control valve may include completely opening the air cut-off valve and the air pressure control valve for voltage rise control of the fuel cell stack, if entering a refresh mode.

The cooperatively controlling of the air cut-off valve and the air pressure control valve may include opening the air pressure control valve to a predetermined opening degree and controlling revolutions per minute (RPM) of an air compressor upward, if entering a refresh mode.

The cooperatively controlling of the air cut-off valve and the air pressure control valve may include determining opening degrees of the air cut-off valve and the air pressure control valve, based on at least one of a target voltage, a voltage rise speed, a voltage drop speed, voltage responsiveness, or a cell voltage deviation, or any combination thereof.

### BRIEF DESCRIPTION OF THE DRAWINGS

The above and other features and advantages of embodiments of the present disclosure can be more apparent from the following detailed description taken in conjunction with the accompanying drawings, in which:

FIG. 1 is a schematic drawing illustrating an apparatus for controlling air supply into a fuel cell stack according to an embodiment of the present disclosure;

FIG. 2 is a drawing for describing a structure of an air pressure control valve (APC) according to an embodiment of the present disclosure;

FIG. 3 illustrates a block configuration diagram of a control unit according to an embodiment of the present disclosure;

FIG. 4 is a flowchart illustrating a method for controlling air supply into a fuel cell stack according to an embodiment of the present disclosure;

FIG. 5 is a graph illustrating an air flow rate for each opening degree of an air cut-off valve (ACV) associated with an embodiment of the present disclosure;

FIG. 6 is a graph illustrating a relationship between a change in pressure of an air processing system (APS) associated with an embodiment of the present disclosure and a change in air flow rate of the APS;

FIG. 7 is a drawing with graphs for describing control of an air processing system (APS) valve according to an embodiment of the present disclosure; and

FIG. 8 is a drawing with graphs for describing a method for controlling air supply into a fuel cell stack according to an embodiment of the present disclosure in contrast to an existing control method.

### DETAILED DESCRIPTION OF ILLUSTRATIVE EMBODIMENTS

Hereinafter, some example embodiments of the present disclosure will be described in detail with reference to the drawings. In adding the reference numerals to the components of each drawing, it can be noted that identical components can be designated by identical numerals even when they are displayed on different drawings. In addition, a detailed description of well-known features or functions can be omitted to not unnecessarily obscure the gist of the present disclosure.

In describing components of example embodiments of the present disclosure, the terms “first,” “second,” “A,” “B,” “(a),” “(b),” and the like, may be used herein. Such terms can be used merely to distinguish one component from another component, but do not necessarily limit the corresponding components irrespective of the order or priority of the corresponding components. Furthermore, unless otherwise defined, terms including technical and scientific terms used herein can have a same meaning as being generally understood by those skilled in the art to which the present disclosure pertains. Such terms as those defined in a generally used dictionary can be interpreted as having meanings equal to the contextual meanings in the relevant field of art, and are not to be interpreted as having ideal or excessively formal meanings unless clearly defined as having such in the present application.

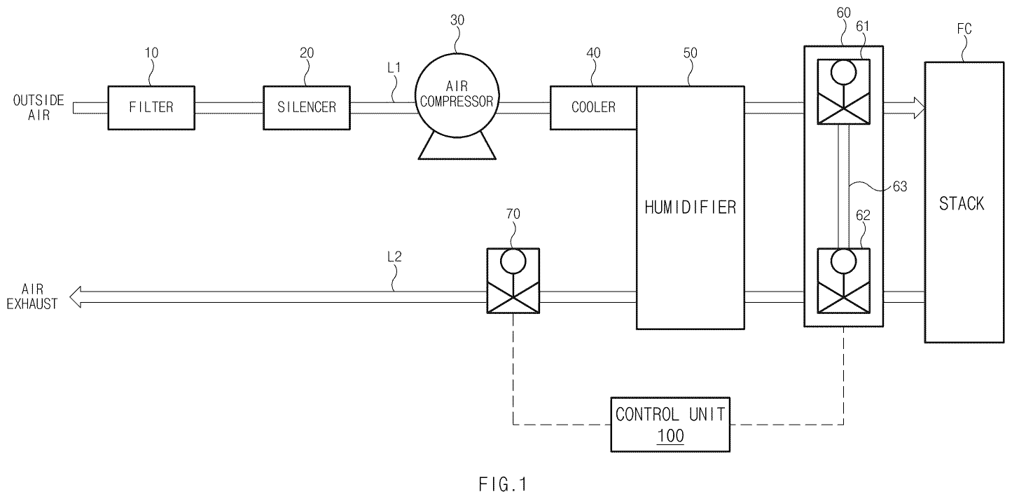

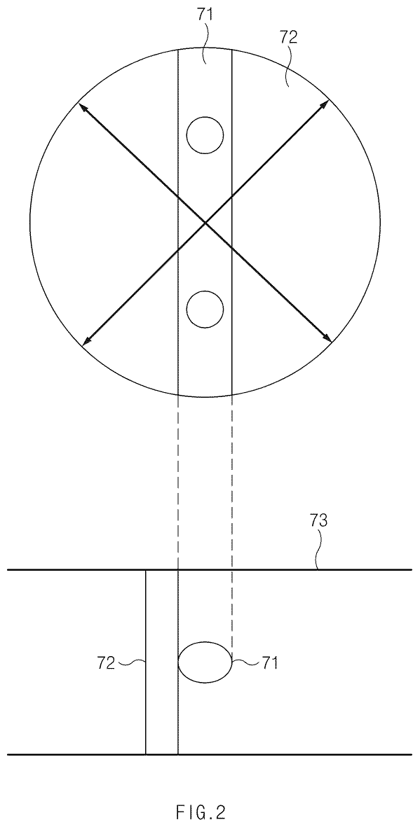

FIG. 1 is a drawing illustrating an apparatus for controlling air supply into a fuel cell stack according to embodiments of the present disclosure. FIG. 2 is a drawing for describing a structure of an air pressure control valve (APC) according to embodiments of the present disclosure.

The apparatus for controlling the air supply may be one component constituting a fuel cell system. Such an apparatus for controlling the air supply may inhale air from the outside and may supply the air to a fuel cell stack FC. In other words, the apparatus for controlling the air supply may supply oxygen captured from outside air and may supply the air to the fuel cell stack FC. The fuel cell stack FC may produce electric energy via an electrochemical reaction between hydrogen supplied from a hydrogen supply device (not shown) and oxygen supplied from the apparatus for controlling the air supply. The fuel cell stack FC may include two catalyst electrodes, that is, an anode and a cathode. If hydrogen and oxygen are provided to the anode and the cathode, respectively, the anode may divide the hydrogen into protons, that is, hydrogen ions and electrons. The hydrogen ions may move to the cathode via an electrolyte layer and may be combined with oxygen in the cathode to produce water (H2O). Electrons pass through an external circuit to generate current. The electric energy generated by the fuel cell stack FC may be stored in a high voltage battery (not shown) or may be directly supplied to a drive motor (not shown). The fuel cell stack FC may emit the produced water together with the electric energy to the outside.

Referring to FIG. 1, the apparatus for controlling the air supply may include a filter 10, a silencer 20, an air compressor 30, a cooler 40, a humidifier 50, an air cut-off valve (ACV) 60, an air pressure control valve (APC) 70, and a control unit 100, any combination of or all of which may be in plural or may include plural components thereof. The filter 10, the silencer 20, the air compressor 30, the cooler 40, the humidifier 50, the ACV 60, and the APC 70 may be collectively referred to as an air processing system (APS).

The filter 10 may be installed on an air supply flow path (or an air supply line or a supply pipe) L1 in which air is supplied to the fuel cell stack FC. The filter 10 may remove a foreign substance (e.g., fine dust, SO2 chemical substance, or the like) included in air inhaled from the outside (or outside air).

The silencer 20 may be installed on the air supply flow path L1 and may be installed between the filter 10 and the air compressor 30. The silencer 20 may remove noise generated in the process of supplying air, the foreign substance of which is removed by the filter 10, to the air compressor 30. In other words, the silencer 20 may remove the noise according to the air supply.

The air compressor 30 may be installed on the air supply flow path L1 to compress air passing through the silencer 20. The air compressor 30 may supply the compressed air to the fuel cell stack FC. The air compressor 30 may include a compression device, a motor, and the like. The air compressor 30 may adjust revolutions per minute (RPM) of the motor to adjust an amount of air (or an air flow rate) supplied to the fuel cell stack FC.

The cooler 40 may be installed on the air supply flow path L1 and may be mounted between the air compressor 30 and the humidifier 50. The cooler 40 may cool air discharged from the air compressor 30 and may supply the cooled air to the humidifier 50.

The humidifier 50 may humidify the cooled air introduced from the cooler 40 via the air supply flow path L1 and may supply the humidified air to the fuel cell stack FC. The humidifier 50 may store water discharged from the fuel cell stack FC via an air exhaust flow path (or an air exhaust line or an exhaust pipe) L2 in a tank (not shown). The humidifier 50 may reuse the water stored in the tank (not shown) to humidify the air cooled by the cooler 40. The humidifier 50 may be applied to protect an electrolytic membrane of the fuel cell stack FC.

The ACV 60 may serve to stop electricity generation of the fuel cell stack FC and block air introduced to an air electrode (or a cathode) of the fuel cell stack FC to ensure stack durability performance. The ACV 60 may include a first valve 61 and a second valve 62. The first valve 61 may be mounted on the air supply flow path L1 between the humidifier 50 and an inlet of the fuel cell stack FC. The second valve 62 may be mounted on the air exhaust flow path L2 between the humidifier 50 and an outlet of the fuel cell stack FC.

A bypass flow path 63 for bypassing the introduced air may be formed between the first valve 61 and the second valve 62. The area of the bypass flow path 63 may be formed by being expanded at a predetermined ratio compared to before. As the area of the bypass flow path 63 is expanded, differential pressure of the bypass flow path 63 of the ACV 60 may be optimized. Although the ACV 60 is opened to the same opening degree as before as the differential pressure of the bypass flow path 63 is optimized, an air flow rate introduced into the fuel cell stack FC may be reduced. As an example, if the area of the bypass flow path 63 is expanded at a predetermined ratio of +109% compared to before, it may be identified that the stack introduction flow rate decreases by −74.7% in the state in which the ACV 60 is opened to the same opening degree. Because it can be impossible or difficult to ensure a gap between the bypass flow path 63 and a surrounding counterpart if the area of the bypass flow path 63 is expanded, the area of the bypass flow path 63 may not be blindly expanded. Due to this, a system designer may determine an area expansion ratio (i.e., a predetermined ratio) of the bypass flow path 63 through testing in advance.

The ACV 60 may block air introduced into the fuel cell stack FC if closed and may bypass air introduced via the bypass flow path 63. The ACV 60 may supply air introduced if opened to the fuel cell stack FC and may block air introduced into the bypass flow path 63.

The APC 70 may be installed on the air exhaust flow path L2, which discharges air that completes reaction in the fuel cell stack FC. As shown in FIG. 2, the APC 70 may include a shaft 71 and a disk 72. The disk 72 may be formed to minimize a clearance that is an interval between an inner wall of an exhaust pipe 73 and the disk 72. The clearance may be defined as a difference between a bore inner diameter of the exhaust pipe 73 and a diameter of the disk 72. In other words, the disk 72 may be formed in an airtight structure with the exhaust pipe 73 to minimize the interval between the inner wall of the exhaust pipe 73 and the disk 72. As the interval between the inner wall of the exhaust pipe 73 and the disk 72 is minimized, if the APC 70 is closed, back pressure may increase compared to before to decrease an air flow rate.

The disk 72 may be fastened to any one side on the basis of the shaft 71. In other words, the shaft 71 and the disk 72 may be fastened to each other in a single offset structure in which the shaft 71 deviates from the center of the disk 72. As an existing structure in which a disk is fastened to a slit groove of a shaft changes to the single offset structure in which the disk 72 is fastened to any one side on the basis of the shaft 71, an air leak that can occur due to a gap between the bore and the shaft may be reduced.

The APC 70 may adjust an angle of the disk 72 to adjust an effective area of the air exhaust flow path L2. In other words, the APC 70 may adjust the angle of the disk 72 (i.e., an APC opening degree) to adjust an amount of air exhaust (or an amount of air discharge). Thus, the APC 70 may adjust running pressure (or air pressure) of the APS by adjusting the angle of the disk 72.

The control unit 100 may adjust an opening degree of an APS valve, that is, the ACV 60 and/or the APC 70, to control air supply into the fuel cell stack FC. The APS valve may include an actuator for adjusting a valve opening degree depending on an opening degree command of the control unit 100.

The control unit 100 may open the ACV 60 while the fuel cell system is normally running and may adjust an opening degree of the APC 70 based on the running pressure of the APS. While the fuel cell stack FC is generating electricity (or is running), the control unit 100 may open the ACV 60 to supply air to the fuel cell stack FC. Furthermore, the control unit 100 may adjust an opening degree of the APC 70 based on predetermined air pressure to adjust an amount of air discharged from the fuel cell stack FC.

If receiving a command instructing to stop electricity generation of the fuel cell stack FC from an upper-level control unit (e.g., an energy management device), the control unit 100 may perform APS valve control for a voltage drop of the fuel cell stack FC. If receiving a command instructing to stop electricity generation of the fuel cell stack FC, the control unit 100 may switch an operation mode of the fuel cell system from a normal running mode to a fuel cell stop mode FC STOP. The control unit 100 may open the ACV 60 to a predetermined first opening degree and may completely close the APC 70 for a voltage drop of the fuel cell stack FC, if entering the fuel cell stop mode. As an example, the control unit 100 may open the ACV 60 to 30° and may completely close the APC 70.

The control unit 100 may wait until the voltage of the fuel cell stack FC reaches a predetermined lower limit voltage. If the voltage of the fuel cell stack FC reaches the predetermined lower limit voltage, the control unit 100 may control to completely open the ACV 60 and repeatedly open and close the APC 70 to a predetermined second opening degree depending on the voltage of the fuel cell stack FC. The control unit 100 may repeatedly open and close the APC 70 to a predetermined opening degree, for example, 15°, such that the voltage of the fuel cell stack FC is maintained within a certain range with respect to the predetermined lower limit voltage. The control unit 100 may repeat the opening and closing of the APC 70 at a predetermined period.

If the operation mode of the fuel cell system switches from the fuel cell stop mode to a refresh mode (or a fuel cell refresh mode), the control unit 100 may completely open the APC 70 for a voltage rise of the fuel cell system FC. In other words, the control unit 100 may control to completely open the ACV 60 and the APC 70 for catalyst refresh to perform air supercharge into the fuel cell stack FC.

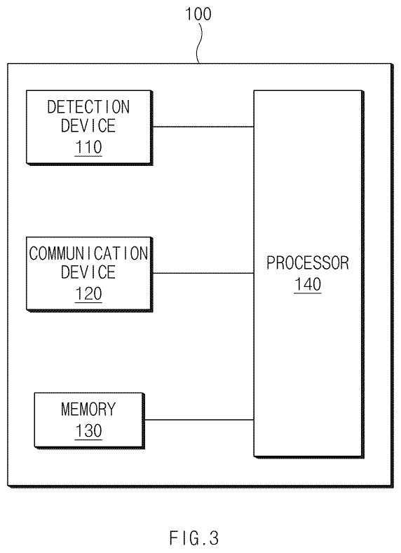

FIG. 3 illustrates a block configuration diagram of a control unit according to embodiments of the present disclosure.

Referring to FIG. 3, a control unit 100 may include a detection device 110, a communication device 120, a memory 130, and a processor 140, any combination of or all of which may be in plural or may include plural components thereof. The control unit 100 may be a fuel cell control unit (FCU).

The detection device 110 may detect state information (e.g., a voltage, a current, and/or the like) of a fuel cell stack FC, an air flow rate of an air processing system (APS), air pressure of the APS, and/or the like. The detection device 110 may measure a voltage, a current, and/or the like of the fuel cell stack FC, using a voltage sensor, a current sensor, and/or the like mounted on the fuel cell stack FC. The detection device 110 may measure an air flow rate, air pressure, and/or the like of the APS, using a flow rate sensor, a pressure sensor, and/or the like mounted on an air supply flow path, an air exhaust flow path, and/or the like.

The communication device 120 may assist the controller 100 to perform communication with an external device (e.g., an air compressor 30, an air cut-off valve (ACV) 60, an air pressure control valve (APC) 70, an upper-level control unit, or the like). The communication device 120 may include a communication circuit that performs wireless communication such as vehicle to infrastructure (V2I) communication, wireless local area network (WLAN) (Wi-Fi), wireless broadband (Wibro), long term evolution (LTE), international mobile telecommunication (IMT)-2020, Bluetooth, and/or near field communication (NFC), for example. The communication device 120 may include a communication circuit that performs wired communication such as local area network (LAN) communication and/or power line communication.

The memory 130 may be a non-transitory storage medium that stores instructions executed by the processor 140. The memory 130 may be implemented as a flash memory, a hard disk, a solid state disk (SSD), a random access memory (RAM), a static RAM (SRAM), a read only memory (ROM), a programmable ROM (PROM), an electrically erasable and programmable ROM (EEPROM), an erasable and programmable ROM (EPROM), and/or the like, or any combination thereof, for example.

The memory 130 may store APS valve control logic, an opening degree of an APC according to air pressure, an opening degree (e.g., a first opening degree, a second opening degree, and/or the like) of the APS valve for stack voltage drop and rise, or the like. The memory 130 may store a P gain map in which a P gain mapped to an error between a current voltage and a target voltage is defined.

The processor 140 may control the overall operation of the control unit 100. The processor 140 may be implemented as an application specific integrated circuit (ASIC), a digital signal processor (DSP), a programmable logic device (PLD), a field programmable gate array (FPGA), a central processing unit (CPU), a microcontroller, a microprocessor, and/or the like, or any combination thereof, for example.

If the output of the fuel cell stack FC will not be used while a fuel cell system is running, the processor 140 may enter a fuel cell stop mode FC STOP. In other words, the processor 140 may switch an operation mode of the fuel cell system from a fuel cell running mode (or a fuel cell generation mode) to the fuel cell stop mode (or a fuel cell generation stop mode).

After entering the fuel cell stop mode, the processor 140 may control running of the APS depending on a running strategy for limiting an upper limit voltage and a lower limit value of the fuel cell stack FC (i.e., an upper limit and a lower limit of a stack voltage). The reason why the upper limit voltage and the lower limit voltage of the fuel cell stack FC may be limited can be because a stack deterioration rate can vary with a stack voltage interval maintained in the fuel cell stop mode. Stack deterioration may occur because OH-(oxygen radical) generated by platinum catalyst elution can degrade an electrolyte membrane. The stack voltage interval may be predetermined by a system designer. The system designer may compare stack deterioration rate patterns for each voltage interval and may optimize the stack voltage interval, that is, an upper limit voltage and a lower limit voltage, based on the compared result.

In other words, if entering the fuel cell stop mode, the processor 140 may adjust an open circuit voltage (OCV) of the fuel cell stack FC. In theory, the OCV may be 1.23 V, if oxygen concentration and hydrogen concentration are the same as each other, and may be 1.219 V depending on the Nernst equation. If any one of an increase in supply gas temperature, imbalance in concentration of hydrogen and oxygen, an internal current, or X-over occurs, the OCV may be smaller than a theoretical value. The X-over can refer to a phenomenon in which hydrogen passes from the hydrogen electrode (or the anode) to the air electrode (or the cathode), or oxygen passes from the air electrode to the hydrogen electrode. The internal current may be generated if the hydrogen molecule is divided in the form of hydrogen ions and electrons in the anode and passes to the cathode via the film. A concentration difference between the hydrogen of the anode and the oxygen of the cathode may change via pressure (or concentration) control for an OCV drop. Furthermore, air can be supplied intermittently if hydrogen is supplied at constant pressure upon lower limit voltage control running, for the OCV drop, such that hydrogen crosses over due to diffusion according to the concentration difference.

The processor 140 may wait until the stack voltage reaches a predetermined target voltage (or upper limit voltage). The processor 140 may maintain an output current (i.e., a stack current) of the fuel cell stack FC as 0 A and may control the stack voltage to follow the predetermined target voltage. The processor 140 may maintain the stack current as 0 A to prevent the battery from being overcharged. The processor 140 may adjust hydrogen pressure (or hydrogen concentration) upward and may adjust opening degrees of the ACV 60 and the APC 70, thus controlling an air flow rate (or an air supply flow rate) supplied to the fuel cell stack FC to a predetermined low flow rate. In other words, the processor 140 may adjust an air flow rate supplied to the fuel cell stack FC, such that the stack voltage follows the target voltage.

If the stack voltage reaches the target voltage, the processor 140 may determine that a lower limit voltage control initiation condition is met. If it is determined that the lower limit voltage control initiation condition is met, the processor 140 may lower the stack voltage based on a predetermined lower limit voltage. The processor 140 may control opening degrees of the ACV 60 and the APC 70 for stack voltage drop control. The processor 140 may adjust the opening degrees of the ACV 60 and the APC 70, using proportional (P) control and feedforward control.

The processor 140 may determine the opening degrees of the ACV 60 and the APC 70 with reference to a P gain map stored in memory 130. The processor 140 may control the opening degrees of the ACV 60 and the APC 70, using an optimal opening degree mapped to an error (or a difference) between the current stack voltage and the target voltage.

The opening degrees of the ACV 60 and the APC 70 may be determined based on at least one of the target voltage (i.e., an upper limit voltage and a lower limit voltage), a voltage rise speed, a voltage drop speed, voltage responsiveness, or a cell voltage deviation, or any combination thereof. The optimal opening degrees of the ACV 60 and the APC 70 may be tuned based on a relationship between a change in pressure of the APS and a change in air flow rate of the APS through testing in advance. The processor 140 may generate a map, that is, a P gain map, in which the optimal opening degrees of the ACV 60 and the APC 70, which correspond to the difference between the current stack voltage and the target voltage, are defined.

If controlling the opening degrees of the ACV 60 and the APC 70, the processor 140 can satisfy the following constraints:
1) The ACV 60 can limit a minimum closing angle for avoiding lip seal wear.
2) The ACV 60 and the APC 70 can have cooperative control for minimizing an operation angle to ensure operation durability.
3) An air compressor using an air foil bearing may fail to more lower motor RPM than idle RPM.

The processor 140 may determine whether the stack voltage reaches a predetermined lower limit voltage. If the stack voltage reaches the predetermined lower limit voltage, the processor 140 may perform voltage maintenance control. The processor 140 may control opening degrees of the ACV 60 and the APC 70, such that the stack voltage does not deviate from a predetermined limit interval (or an allowable range) with respect to the predetermined lower limit voltage. The processor 140 may open the opening degree of the ACV 60 to a maximum opening degree (e.g., 45°) and may open the opening degree of the APC 70 to a maximum opening degree (e.g., 15°) for voltage maintenance, thus controlling the opening degree of the APC 70 to a predetermined minimum opening degree (e.g., 0°) if a predetermined time elapses.

The processor 140 may maintain voltage maintenance control and may determine whether to refresh the fuel cell stack FC. If it is determined to refresh the fuel cell stack FC, the processor 140 may perform voltage rise control. The processor 140 may control the opening degrees of the ACV 60 and the APC 70, based on a difference between the current stack voltage and a predetermined upper limit voltage (i.e., a target voltage). The processor 140 may open each of the opening degrees of the ACV 60 and the APC 70 to the maximum opening degree to supercharge the fuel cell stack FC.

The processor 140 may perform voltage rise control and may determine whether to release a fuel cell stop mode. If it is determined to release the fuel cell stop mode, the processor 140 may switch an operation mode of a fuel cell system from the fuel cell stop mode to a fuel cell running mode. If it is determined not to release the fuel cell stop mode, the processor 140 may perform (or maintain) the lower limit voltage again.

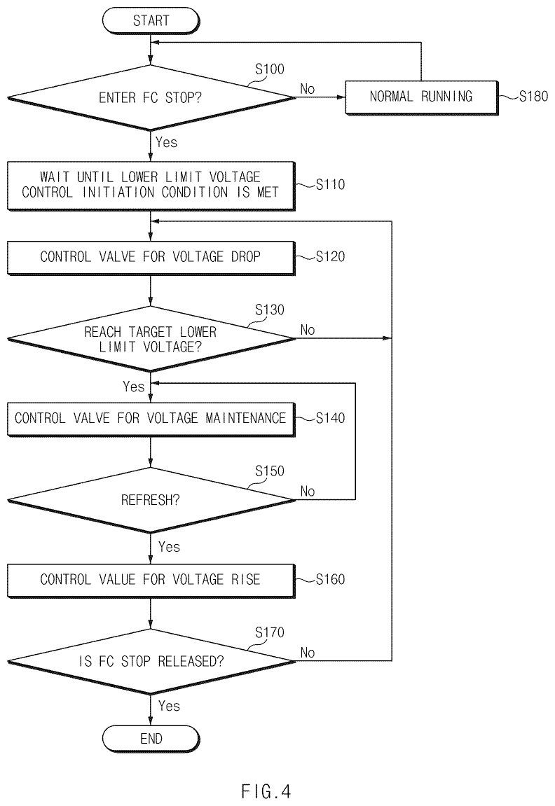

FIG. 4 is a flowchart illustrating a method for controlling air supply into a fuel cell stack according to an embodiment of the present disclosure.

In operation S100, a processor 140 of a control unit 100 may determine whether to enter a fuel cell stop mode FC STOP, while a fuel cell system is running. If receiving a stack output stop request via a communication device 120, for example, if a vehicle is stopped, the processor 140 may determine to enter the fuel cell stop mode FC STOP. If it is determined to enter the fuel cell stop mode FC STOP, the processor 140 may switch an operation mode of the fuel cell system from a fuel cell running mode to the fuel cell stop mode FC STOP.

If it is determined to enter the fuel cell stop mode FC STOP, in operation S110, the processor 140 may wait until a lower limit voltage control initiation condition is met. After entering the fuel cell stop mode FC STOP, the processor 140 may maintain an output current (or a stack current) of a fuel cell stack FC as 0 A and may determine whether a voltage of the fuel cell stack FC (or a stack voltage) reaches a predetermined upper limit voltage (e.g., 0.85 V). If it is determined that the stack voltage reaches the predetermined upper limit voltage, the processor 140 may maintain the stack voltage as the predetermined upper limit voltage and may wait during a predetermined time.

In operation S120, the processor 140 may control an ACV 60 and an APC 70, such that the voltage of the fuel cell stack FC (hereinafter referred to as a “stack voltage”) drops at a predetermined voltage speed V/sec. The processor 140 may adjust an opening degree of the ACV 60 to a predetermined fixed opening degree and may adjust an opening degree of the APC 70 to a completely closed state.

In operation S130, the processor 140 may determine whether the stack voltage reaches a target lower limit voltage. The processor 140 may measure a stack voltage by use of a detection device 110. The processor 140 may compare the measured stack voltage with the predetermined target lower limit voltage and may determine whether the stack voltage reaches the target lower limit voltage based on the compared result.

If it is determined that the stack voltage reaches the target lower limit voltage, in operation S140, the processor 140 may perform valve control for maintaining the stack voltage. The processor 140 may control the ACV 60 and the APC 70, such that the stack voltage is maintained within a predetermined lower limit voltage range, that is, an allowable range with respect to the target lower limit voltage.

In operation S150, the processor 140 may perform valve control for maintaining the stack voltage and may determine whether to refresh the fuel cell stack FC. If receiving a refresh mode entry command from an upper-level control unit via the communication device 120, the processor 140 may determine to enter a refresh mode.

If it is determined to refresh the fuel cell stack FC, in operation S160, the processor 140 may perform valve control for increasing the stack voltage. The processor 140 may open each of opening degrees of the ACV 60 and the APC 70 to a maximum opening degree to restore the stack voltage to a predetermined upper limit voltage. The processor 140 may switch the opening degree of the APC 70 to a completely open state to decrease running pressure and facilitate air supply and may control RPM of an air compressor 30 to predetermined RPM upward in an idle state. The processor 140 may adjust the opening degree of the APC 70 to a predetermined opening degree, such that the air compressor 30 shares air supply.

Next, in operation S170, the processor 140 may determine whether to release the fuel cell stop mode FC STOP. If receiving a stack output resumption request via the communication device 120, the processor 140 may determine to release the fuel cell stop mode FC STOP. The processor 140 may end lower the limit voltage control of the fuel cell stack FC by releasing the fuel cell stop mode FC STOP.

If it is determined not to enter the fuel cell stop mode FC STOP in operation $100, in operation S180, the processor 140 may normally run the fuel cell system. The processor 140 may open the ACV 60 and may adjust the opening degree of the APC 70 based on running pressure of an APS. While the fuel cell stack FC is generating electricity (or is running), the processor 140 may open the ACV 60 to supply air to the fuel cell stack FC. Furthermore, the processor 140 may adjust the opening degree of the APC 70 based on predetermined air pressure to adjust an air flow rate supplied to the fuel cell stack FC.

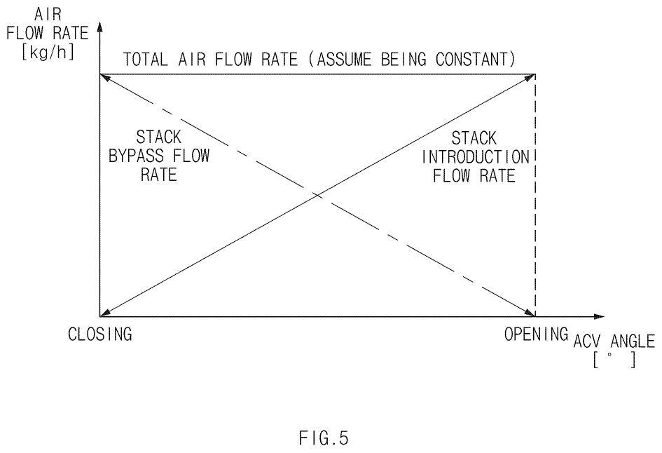

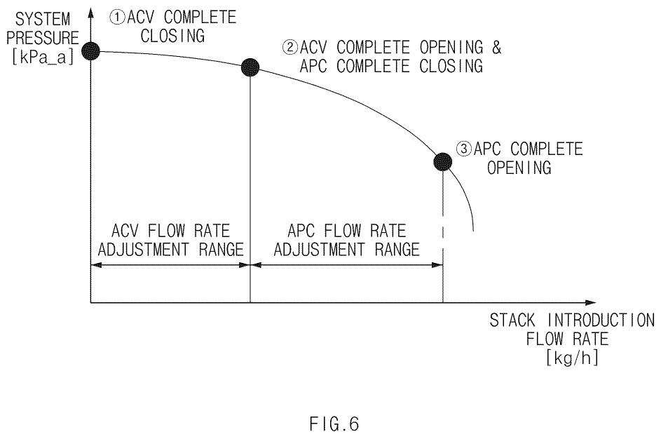

FIG. 5 is a graph illustrating an air flow rate for each opening degree of an air cut-off valve (ACV) associated with embodiments the present disclosure. FIG. 6 is a graph illustrating a relationship between a change in pressure of an air processing system (APS) associated with embodiments the present disclosure and a change in air flow rate of the APS.

Referring to FIG. 5, as an opening degree of the ACV, that is, an ACV opening degree increases, a bypass flow rate may decrease and a stack introduction flow rate (or a stack supply flow rate) may increase. At this time, ideally, a total air flow rate may be kept constant. An ACV 60 may be located at a front stage of a fuel cell stack FC to supply air to the fuel cell stack FC if it is completely open and bypass the fuel cell stack FC to discharge air to an outlet if it is completely closed. If the opening degree of the ACV 60 lies at an intermediate angle, the distribution of flowing air may be determined according to differential pressure of each diverging flow path. Thus, the total air flow rate may actually change without being maintained and each diverging flow rate may be represented as being non-linear.

A graph shown in FIG. 6 indicates a relationship between system pressure from intake to exhaust in an air processing system (APS) and a stack supply flow rate. If an air compressor 30 is driven at idle RPM, an operation point may change depending on a change in opening degrees of an ACV 60 and an APC 70. Upon normal driving, the opening degree of the ACV 60 may be fixed in a completely open state and the opening degree of the APC 70 may be adjusted according to system pressure. As system pressure changes according to a change in the opening degree of the APC 70, an air flow rate supplied to the fuel cell stack FC may change.

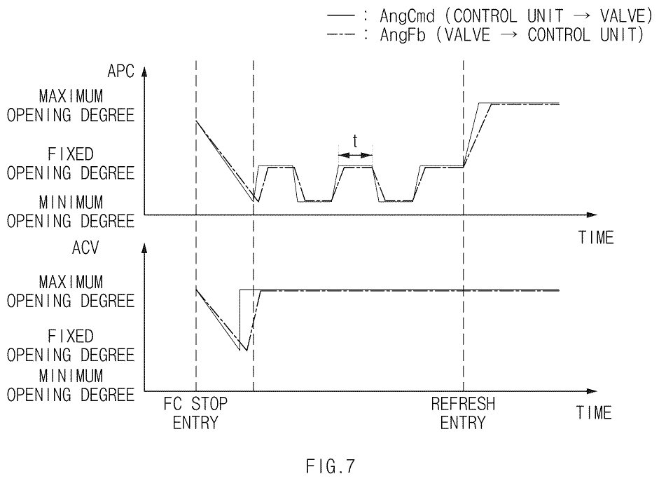

FIG. 7 is a drawing for describing control of an air processing system (APS) valve according to embodiments of the present disclosure.

Referring to FIG. 7, if entering a fuel cell stop mode FC STOP, a control unit 100 may block air supplied to a fuel cell stack FC. At this time, the control unit 100 may stop driving of an air compressor 30 to block air supply into the fuel cell stack FC. The control unit 100 may perform cooperative control of an ACV 60 and an APC 70 for maintaining an OCV of the fuel cell stack FC (hereinafter referred to as a “stack voltage”) as a predetermined voltage.

After entering the fuel cell stop mode FC STOP, the control unit 100 may transmit an APC opening degree control command APC AngCmd to the APC 70. The APC opening degree control command may include an APC opening degree drop slope [X°/s] for stack voltage drop and a minimum APC opening degree. The APC 70 may control an APC opening degree depending on the APC opening degree drop slope included in the APC opening degree control command. The APC 70 may control the APC opening degree and may feed back a current APC opening degree APC AngFb to the control unit 100. The control unit 100 may determine whether the current APC opening degree fed back from the APC 70 reaches the minimum APC opening degree (e.g., 0°) included in the APC opening degree control command.

Furthermore, after entering the fuel cell stop mode FC STOP, the control unit 100 may transmit an ACV opening degree control command ACV AngCmd to the ACV 60. The ACV opening degree control command may include an ACV opening degree drop slope [Z°/s] for stack voltage drop and a fixed ACV opening degree for satisfying a target voltage following speed of the stack voltage. The ACV 60 may control an ACV opening degree depending on the ACV opening degree drop slope. The ACV 60 may control the ACV opening degree and may measure and transmit (or feed back) a current ACV opening degree ACV AngFb to the control unit 100. The control unit 100 may determine whether the current ACV opening degree transmitted from the ACV 60 reaches the fixed ACV opening degree.

If it is determined that the APC opening degree reaches the minimum APC opening degree, the control unit 100 may transmit an APC opening degree control command APC AngCmd for stack voltage maintenance to the APC 70. The APC opening degree control command may include a minimum APC opening degree, a maximum APC opening degree for stack voltage maintenance, and opening degree change timing information. The control unit 100 may control an APC opening degree based on the maximum APC opening degree for stack voltage maintenance. The control unit 100 may alternately control the APC opening degree to the maximum APC opening degree for stack voltage maintenance and the minimum APC opening degree, based on the opening degree change timing information. In other words, the control unit 100 may maintain the APC opening degree as the maximum APC opening degree for stack voltage maintenance during a predetermined time t to switch the APC opening degree from the maximum APC opening degree for stack voltage maintenance to the minimum APC opening degree and may maintain the APC opening degree as the minimum APC opening degree during the predetermined time t to switch the APC opening degree from the minimum APC opening degree to the maximum APC opening degree for stack voltage maintenance.

Furthermore, if it is determined that the ACV opening degree reaches the fixed ACV opening degree, the control unit 100 may transmit an ACV opening degree control command ACV AngCmd including a maximum ACV opening degree to the ACV 60. The ACV 60 may adjust the ACV opening degree to the maximum ACV opening degree.

The control unit 100 may perform stack voltage maintenance control and may determine whether to enter a fuel cell refresh mode. If it is determined to enter the fuel cell refresh mode, the control unit 100 may resume air supply into the fuel cell stack FC. At this time, the control unit 100 may resume driving of an air compressor 30 to perform air supply into the fuel cell stack FC.

After entering the fuel cell refresh mode, the control unit 100 may transmit an APC opening degree control command for stack voltage rise to the APC 70. The APC opening degree control command may include an APC opening degree rise slope [Y°/s] for stack voltage rise and a maximum APC opening degree. The APC 70 may adjust an APC opening degree based on the APC opening degree rise slope. The APC 70 may control the APC opening rise and may measure and transmit a current APC opening degree to the control unit 100. The control unit 100 may compare the current APC opening degree transmitted from the APC 70 with the maximum APC opening degree. If the current APC opening degree and the maximum APC opening degree are identical to each other, the control unit 100 may determine that the APC opening degree reaches the maximum APC opening degree. If it is determined that the APC opening degree reaches the maximum APC opening degree, the control unit 100 may maintain the current APC opening degree.

Furthermore, after entering the fuel cell refresh mode, the control unit 100 may transmit the ACV opening degree control command ACV AngCmd including the maximum ACV opening degree to the ACV 60 to maintain the ACV opening degree as the maximum ACV opening degree.

Selecting valve opening degree specifications for controlling the stack voltage to maintain a predetermined lower limit voltage in the fuel cell stop mode may be based on the following.

If the ACV 60 is completely closed, it can be possible to follow a lower limit voltage of the stack voltage, but it can be impossible or difficult to ensure durability as a rubber lip seal is continuously worn out due to a completely closing operation of the ACV 60 for blocking air. If the ACV 60 is slightly open to avoid the wear of the rubber lip seal, although the APC 70 is closed, it can be impossible or difficult to follow the lower limit voltage of the stack voltage. Thus, the hardware structure of the APC 70 can be developed as an airtight type, such that it can be possible to follow the lower limit voltage of the stack voltage if the APC 70 is completely closed on the basis of the amount of bore leak of the APC 70. If the APC 70 is completely closed, it can be possible for the ACV 60 to be completely open. However, an intermediate fixed opening degree capable of using a bypass flow path of the ACV 60 may be selected as an ACV opening degree to improve a speed for following the lower limit voltage of the stack voltage.

To maintain a lower limit voltage interval after following the lower limit voltage, air can be intermittently supplied to the fuel cell stack FC. If the APC opening degree is adjusted, a supply flow rate for each opening degree may be adjusted according to an operation point of a pressure-flow chart. At this time, timing for changing a valve opening degree can be important. The valve opening degree change timing may be determined with regard to slight latency that can be present if a flow rate is supplied and a voltage changes. In other words, the valve opening degree change timing may be determined before the current stack voltage reaches a target voltage by a predetermined ratio (e.g., 3%). If the stack voltage enters within the predetermined ratio of the target voltage, the control unit 100 may select an ACV opening degree as complete opening to block a bypass flow path 63. This can be because a total amount of operation in which the APC 70 should move for voltage maintenance can increase as a voltage change speed is fast if the bypass flow path 63 is used even after following the lower limit voltage of the stack voltage. The ACV opening degree may be selected as the complete opening to ensure durability of the APC 70.

Air supercharge for being restored to an upper limit voltage can be performed for catalyst refresh after the lower limit voltage interval is maintained. The control unit 100 may adjust the APC opening degree to complete opening to decrease system pressure, thus increasing a supply flow rate. Because the voltage rise speed can be also important like the voltage drop control, RPM of the air compressor 30 may increase to increase a supply flow rate of air. At this time, the APC opening degree may be selected as an intermediate fixed opening degree rather than complete opening to ensure durability of the APC 70. The RPM of the air compressor 30 may be controlled more upward, such that the air compressor 30 shares air supply.

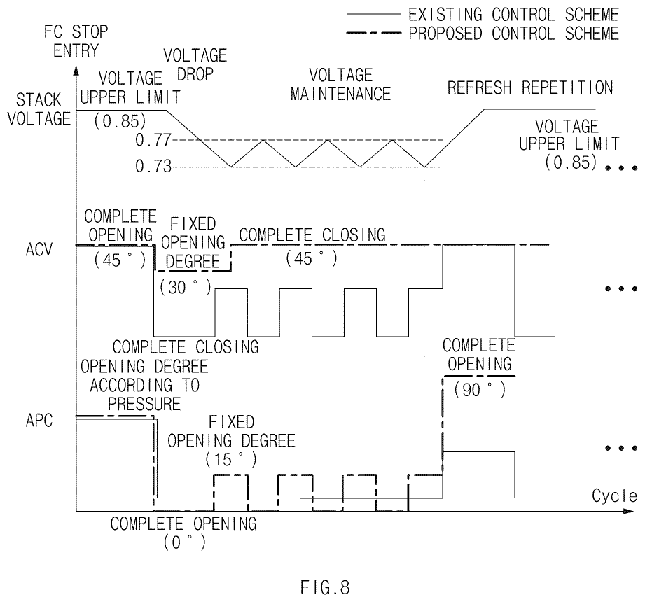

FIG. 8 is a drawing for describing a scheme for controlling air supply into a fuel cell stack according to an embodiment of the present disclosure in contrast to an existing control scheme.

After a fuel cell system enters a fuel cell stop mode FC STOP, a control unit 100 may wait in a state in which the stack voltage is a voltage upper limit (e.g., 0.85 V) and the stack current is 0 A.

After waiting during a predetermined time, the control unit 100 may adjust an opening degree of an ACV 60 to a predetermined fixed opening degree (e.g., 30°) and may adjust an opening degree of an APC 70 to a completely closed state (e.g., 0°), thus lowering the stack voltage. The opening degrees of the ACV 60 and the APC 70 may be controlled by a map obtained by tuning P gain values of a target voltage and a current voltage after selecting a feedforward value through testing in advance.

If the stack voltage reaches a lower limit voltage (e.g., 0.73 V), the control unit 100 may intermittently supply air, such that the stack voltage is maintained within an allowable range (or interval) with respect to the lower limit voltage. The control unit 100 may adjust the opening degrees of the ACV 60 and the APC 70, based on an ACV opening degree and an APC opening degree, which can be optimized through testing in advance, to maintain the stack voltage as the lower limit voltage. If the stack voltage reaches the lower limit voltage (e.g., 0.73 V), the control unit 100 may change the opening degree of the ACV 60 from a predetermined fixed opening degree (e.g., 30°) to a completely open state (e.g., 45°). Furthermore, the control unit 100 may change the opening degree of the APC 70 from a completely closed state to a predetermined fixed opening degree (e.g., 15°) and may change the opening degree of the APC 70 from the predetermined fixed opening degree (e.g., 15°) to the completely closed state, if opening degree change timing is reached. Furthermore, the control unit 100 may alternate the opening degree of the APC 70 between the completed closed state and the predetermined fixed opening degree (e.g., 15°), until it is determined to enter a refresh mode. In other words, the control unit 100 may fix the ACV opening degree to the completely open state and may control the APC opening degree at a predetermined opening degree change time (timing), thus adjusting an air flow rate supplied to the fuel cell stack FC. The stack voltage changes depending on the air flow rate. However, at this time, because there can be latency, the opening degree can change before an upper limit or a lower limit of the allowable range with respect to the lower limit voltage (or the voltage limit interval) is reached by a predetermined ratio (e.g., 3%) not to deviate from the allowable range.

If the fuel cell system enters the refresh mode, the control unit 100 can perform air supercharge to restore a voltage upper limit of the stack voltage for catalyst refresh.

The control unit 100 may adjust the APC opening degree to a completely open state to lower APS pressure and facilitate air supply and may increase RPM of the air compressor 30 in an idle state. Furthermore, the controller 100 may adjust the APC opening degree to a predetermined fixed opening degree rather than complete opening, such that the air compressor 30 shares air supercharge.

Because the ACV 60 can be open at the predetermined opening degree in the air supply control scheme proposed above unlike an existing control scheme for repeating the completely closing operation of the ACV 60, the wear of a rubber lip seal due to the completely closing operation of the ACV 60 may be avoided to improve durability of the ACV 60.

Furthermore, unlike the existing control scheme for fixing and opening the APC 70 to a specific opening degree, in the air supply control scheme proposed above, an air supply flow rate may be adjusted by adjusting the opening degree of the APC 70 in the state in which the ACV 60 is completely open.

Embodiments of the present disclosure may control and optimize an air processing system (APS) valve for limiting a voltage lower limit of a fuel cell stack, if stopping a fuel cell, with regard to a hardware characteristic and function of the APS, thus preventing an excessive operation of the valve to improve durability and preventing cost from increasing.

Furthermore, embodiments of the present disclosure may cooperatively control an air cut-off valve (ACV) and an air pressure control valve (APC) in an idle state of the fuel cell stack, thus maintaining a stack voltage within a predetermined lower limit voltage range.

Furthermore, embodiments of the present disclosure may prevent rubber powder from being introduced into the stack and may prevent air from being introduced into the cathode due to the opening of the air cut-off valve (ACV), if controlling to avoid an opening degree interval in which the rubber lip seal is worn out, thus preventing a reverse voltage from being generated in the fuel cell stack.

Hereinabove, although the present disclosure has been described with reference to example embodiments and the accompanying drawings, the present disclosure is not necessarily limited thereto, and may be variously modified and altered by those skilled in the art to which the present disclosure pertains without departing from the spirit and scopes of the present disclosure claimed in the following claims. Therefore, example embodiments of the present disclosure are not intended to necessarily limit the technical spirit of the present disclosure, but are provided for illustrative purposes. The scopes of the present disclosure can be construed on the basis of the accompanying claims, and all technical ideas within scopes equivalent to the claims can be included in the scopes of the present disclosure.

What is claimed is:

1. An apparatus for controlling air supply into a fuel cell stack, the apparatus comprising:
an air cut-off valve configured to adjust the air supply into the fuel cell stack;
an air pressure control valve configured to adjust air pressure supplied to the fuel cell stack; and
a control unit configured to cooperatively control the air cut-off valve and the air pressure control valve, such that a voltage of the fuel cell stack is maintained as a lower limit voltage if entering a fuel cell stop mode.

2. The apparatus of claim 1, wherein the air cut-off valve comprises:
a first valve disposed on an inlet of the fuel cell stack;
a second valve disposed on an outlet of the fuel cell stack; and
a bypass flow path connecting between the first valve and the second valve and configured to bypass air introduced into the fuel cell stack, wherein the bypass flow path is configured such that an area of the bypass flow path is formed by being expanded at an area expansion ratio.

3. The apparatus of claim 1, wherein the air pressure control valve comprises:
a shaft; and
a disk fastened in a single offset structure with the shaft, wherein the disk is configured to form an airtight structure with an exhaust pipe.

4. The apparatus of claim 1, wherein the control unit is configured to:
open the air cut-off valve to a first opening degree and completely close the air pressure control valve for voltage drop control of the fuel cell stack, after entering the fuel cell stop mode;
completely open the air cut-off valve to maintain the voltage of the fuel cell stack within an allowable range with respect to the lower limit voltage, if the voltage of the fuel cell stack reaches the lower limit voltage; and
repeatedly control to open and close the air pressure control valve to a second opening degree based on the voltage of the fuel cell stack.

5. The apparatus of claim 4, wherein the control unit is further configured to initiate the voltage drop control of the fuel cell stack, if the voltage of the fuel cell stack reaches an upper limit voltage, after entering the fuel cell stop mode.

6. The apparatus of claim 4, wherein the control unit is further configured to:
completely close the air pressure control valve, before the voltage of the fuel cell stack reaches an upper limit of the allowable range with respect to the lower limit voltage; and
open the air pressure control valve to the second opening degree, before the voltage of the fuel cell stack reaches a lower limit of the allowable range with respect to the lower limit voltage.

7. The apparatus of claim 6, wherein the control unit is further configured to alternately control to change an opening degree amount of the air pressure control valve from the complete closing to the second opening degree or change the opening degree amount of the air pressure control valve from the second opening degree to the complete closing, based on opening degree change timing information.

8. The apparatus of claim 4, wherein the control unit is further configured to completely open the air cut-off valve and the air pressure control valve for voltage rise control of the fuel cell stack, if entering a refresh mode.

9. The apparatus of claim 4, wherein the control unit is further configured to open the air pressure control valve to a third opening degree and control revolutions per minute (RPM) of an air compressor upward, if entering a refresh mode.

10. The apparatus of claim 1, wherein the control unit is configured to determine opening degrees of the air cut-off valve and the air pressure control valve, based on one of or any combination of a target voltage, a voltage rise speed, a voltage drop speed, voltage responsiveness, or a cell voltage deviation.

11. A method for controlling air supply into a fuel cell stack, the method comprising:
determining whether to enter a fuel cell stop mode; and
cooperatively controlling an air cut-off valve and an air pressure control valve, such that a voltage of a fuel cell stack is maintained as a lower limit voltage, if it is determined to enter the fuel cell stop mode.

12. The method of claim 11, wherein the cooperatively controlling of the air cut-off valve and the air pressure control valve comprises:
opening the air cut-off valve to a first opening degree and completely closing the air pressure control valve for voltage drop control of the fuel cell stack, after entering the fuel cell stop mode; and
completely opening the air cut-off valve to maintain the voltage of the fuel cell stack within an allowable range with respect to the lower limit voltage, if the voltage of the fuel cell stack reaches the lower limit voltage, and repeatedly controlling to open and close the air pressure control valve to a second opening degree based on the voltage of the fuel cell stack.

13. The method of claim 12, further comprising initiating the voltage drop control of the fuel cell stack, if the voltage of the fuel cell stack reaches a upper limit voltage, after entering the fuel cell stop mode.

14. The method of claim 12, further comprising:
completely closing the air pressure control valve, before the voltage of the fuel cell stack reaches an upper limit of the allowable range with respect to the lower limit voltage; and
opening the air pressure control valve to the second opening degree, before the voltage of the fuel cell stack reaches a lower limit of the allowable range with respect to the lower limit voltage.

15. The method of claim 12, further comprising alternately controlling to change an opening degree amount of the air pressure control valve from the complete closing to the second opening degree or change the opening degree amount of the air pressure control valve from the second opening degree to the complete closing, based on opening degree change timing information.

16. The method of claim 11, wherein the cooperatively controlling of the air cut-off valve and the air pressure control valve comprises completely opening the air cut-off valve and the air pressure control valve for voltage rise control of the fuel cell stack, if entering a refresh mode.

17. The method of claim 11, wherein the cooperatively controlling of the air cut-off valve and the air pressure control valve comprises opening the air pressure control valve to a third opening degree and controlling revolutions per minute (RPM) of an air compressor upward, if entering a refresh mode.

18. The method of claim 11, wherein the cooperatively controlling of the air cut-off valve and the air pressure control valve comprises determining opening degrees of the air cut-off valve and the air pressure control valve, based on one of or any combination of a target voltage, a voltage rise speed, a voltage drop speed, voltage responsiveness, or a cell voltage deviation.

19. An apparatus for controlling air supply into a fuel cell stack, the apparatus comprising:
an air cut-off valve configured to adjust the air supply into the fuel cell stack, wherein the air cut-off valve includes:
a first valve on an inlet of the fuel cell stack,
a second valve on an outlet of the fuel cell stack, and
a bypass flow path connecting between the first valve and the second valve and configured to bypass air away from the fuel cell stack;
an air pressure control valve configured to adjust air pressure supplied to the fuel cell stack, wherein the air pressure control valve is downstream of the second valve, and wherein the air pressure control valve is configured to form an airtight seal at an exhaust pipe of the fuel cell stack; and
a control unit including one or more processors and a storage medium storing computer-readable instructions that, when executed by the one or more processors, enable the one or more processors to cooperatively control the air cut-off valve and the air pressure control valve, such that a voltage of the fuel cell stack is maintained as a lower limit voltage if entering a fuel cell stop mode, wherein the cooperatively control includes:
opening the air cut-off valve to a first opening degree and closing the air pressure control valve for voltage drop control of the fuel cell stack, after entering the fuel cell stop mode,
opening the air cut-off valve to maintain the voltage of the fuel cell stack within an allowable range with respect to the lower limit voltage, if the voltage of the fuel cell stack reaches the lower limit voltage,
repeatedly controlling opening and closing of the air pressure control valve to a second opening degree based on the voltage of the fuel cell stack,
initiating the voltage drop control of the fuel cell stack, if the voltage of the fuel cell stack reaches an upper limit voltage, after entering the fuel cell stop mode,
closing the air pressure control valve, before the voltage of the fuel cell stack reaches an upper limit of the allowable range with respect to the lower limit voltage,
opening the air pressure control valve to the second opening degree, before the voltage of the fuel cell stack reaches a lower limit of the allowable range with respect to the lower limit voltage, and
alternately controlling to change an opening degree amount of the air pressure control valve from closed to the second opening degree or change the opening degree amount of the air pressure control valve from the second opening degree to closed, based on opening degree change timing information.

20. The apparatus of claim 19, wherein the instructions further enable the one or more processors to determine opening degrees of the air cut-off valve and the air pressure control valve, based on one of or any combination of a target voltage, a voltage rise speed, a voltage drop speed, voltage responsiveness, or a cell voltage deviation.
